(19) United States
(12) Patent Application Publication
(10) Pub. No.: US 2025/0269825 A1
(43) Pub. Date: Aug. 28, 2025

(54) METHOD FOR CLEANING A CARGO SPACE OF A TRANSPORT DEVICE

(71) Applicant: Katma Engineering GmbH, Rietberg (DE)

(72) Inventors: FELIX KATHOEFER, Rietberg (DE); Patrick Kathoefer, Duesseldorf (DE)

(21) Appl. No.: 19/071,885

(22) Filed: Mar. 6, 2025

Related U.S. Application Data
(63) Continuation of application No. PCT/EP2023/074400, filed on Sep. 6, 2023.

(30) Foreign Application Priority Data
Sep. 7, 2022 (DE) 102022122692.1

(51) Int. Cl. B60S 3/00; B08B 3/02; B08B 9/093

(52) U.S. Cl. CPC B60S 3/008; B08B 3/024; B08B 9/093; B60S 3/002

(57) ABSTRACT

A method for cleaning a cargo space of a transport device, the method including automatically cleaning the cargo space through a cleaning robot; capturing information including an identification feature of the transport device through a sensor and transmitting the information to a data processing device; comparing the captured information through the data processing device with information stored in a database relating to the transport device so that the transport device is identified; automatically generating a cleaning certificate after cleaning the cargo space of the transport device, wherein the cleaning certificate documents completing cleaning the cargo space; and storing the cleaning certificate in a database so that the cleaning certificate is linked to the transport device.

### RELATED APPLICATIONS

This application is a continuation of international patent application PCT/EP2023/074400, filed on Sep. 6, 2023, claiming priority from German patent application DE 10 2022 122 692.1, filed on Sep. 7, 2022, both of which are incorporated in their entirety by this reference.

### FIELD OF THE INVENTION

The instant application relates to a method for cleaning a cargo space of a transport device.

### BACKGROUND OF THE INVENTION

A generic cleaning method is known in the art. Thus, it is known in the art like e.g. from the publication document DE 10 2019 004 959 A1. This document discloses a cleaning robot suitable for cleaning a cargo space of a transport device. The cleaning robot is moved into the cargo space of the transport device in order to perform the cleaning, wherein the cleaning robot is movable by its own propulsion within the cargo space. Cleaning the surfaces of the walls of the transport device is typically performed by dispensing a cleaning fluid that is sprayed by cleaning nozzles. All wall surfaces of the transport device are wetted by the cleaning fluid while the cleaning robot moves along the longitudinal axis of the cargo space so that the entire cargo space is cleaned. The cleaning robot is removed from the cargo space after the cleaning is complete.

In many applications, there are documentation requirements for cleaning a cargo space of a transport device. Thus, a user of the respective transport device typically has to document successful cleaning of the transport device. This documentation can be required e.g., by a controlling authority, e.g. a government office or by a customer that contracts the services of the operator of the transport device. In particular, the complexity of managing the documentation of cleaning processes of various transport devices can be substantial for operators that run a large fleet of transport devices.

Reference is made to the publication document WO 2013 044825282 A2. This method relates to process control of a tank cleaning process of a transport tank, wherein the transport tank is cleaned using a cleaning fluid, the method comprising: storing a transport tank identifier in a digital memory, storing a starting time of the cleaning process in a digital memory, performing a first series of measurements of a cleaning fluid parameter during the cleaning process upstream from the spot where the cleaning fluid contacts an interior of the transport tank. Storing a finish time of the cleaning process in a digital memory, transmitting a plurality of measured cleaning fluid parameters, a starting time, a finish time, and a transport tank identifier to a data memory that is remote from the tank cleaning apparatus and performing statistical analysis upon a series of measured cleaning fluid parameters.

### BRIEF SUMMARY OF THE INVENTION

It is an object of the invention to provide a method that simplifies documenting a cleaning of a respective cargo space.

The object of the invention is achieved by a method for cleaning a cargo space of a transport device, the method including automatically cleaning the cargo space through a cleaning robot; capturing information including an identification feature of the transport device through a sensor and transmitting the information to a data processing device; comparing the captured information through the data processing device with information stored in a database relating to the transport device so that the transport device is identified; automatically generating a cleaning certificate after cleaning the cargo space of the transport device, wherein the cleaning certificate documents completing cleaning the cargo space; and storing the cleaning certificate in a database so that the cleaning certificate is linked to the transport device.

Advantageous embodiments can be derived from the associated dependent claims.

The method uses a cleaning robot that performs at least one cleaning process automatically or self-acting. The cargo space of the transport device is cleaned by the cleaning robot during the cleaning process. Self-acting or automatic means according to the instant application that cleaning the cargo space is performed without user interaction. A user may manually select a cleaning program wherein the cargo space is to be cleaned according to the cleaning program. The cleaning program defines operating parameters for the cleaning robot for performing at least one cleaning process, e.g. a temperature of the cleaning fluid, a fluid amount to be dispensed, and/or a concentration of a cleaning agent in the cleaning fluid. The cleaning robot can subsequently clean the cargo space without user interaction and thus operates self-acting or automatically according to the invention. At least one operating parameter is adjustable once or several times during the cleaning process.

The transport device can be in particular a truck or a semi-trailer. The cargo space is typically formed by walls, in particular, a cargo space floor, a cargo space ceiling, lateral walls and a face wall, wherein the cargo space floor, the cargo space ceiling, and the walls jointly define a cuboid. One of the walls typically opposite from the face wall is configured open-able, e.g., by pivoting doors, so that the cargo typically configured as solid objects is moveable into the cargo space and removable from the cargo space. The openable wall is typically closed in order to perform the transportation, and the respective cargo is secured in the cargo space.

Cleaning the cargo space can include one cleaning run or several cleaning runs. A cleaning run can include, in particular, a movement of the cleaning robot initially forward in a main direction of the cleaning robot along an entire length of the cargo space and then back opposite to the main direction along the entire length of the cargo space. Depending on a contamination of the cargo space, plural cleaning processes can be required in order to achieve a desired cleanliness of the cargo space.

The method according to the invention initially captures information regarding at least one identifying feature of the transport device to be cleaned using a sensor. The identifying feature can be, in particular, a vehicle license plate that is optically detected e.g. by a sensor configured as a camera. It is also conceivable that the identifying feature is configured as a bar code or QR code that are optically detectable as well. Additionally, the identification can be performed by wireless communication, e.g., by an RFID chip at the transport device and by reading the RFID chip with a suitable sensor. Additional variants for capturing information of at least one identifying feature through at least one sensor is also conceivable.

The captured information is then transmitted to a data processing device. The data processing device can be arranged locally in an area of the sensor and communicate with the sensor through hard wiring or wireless. It is also conceivable that the data processing device is reachable through the internet, wherein the sensor cooperates e.g. with a transceiver configured to transmit the captured information to the data processing device.

The data processing device compares the captured information with information stored in the database, wherein the information stored in the database relates to the same transport device. Comparing the information identifies the transport device. Thus, it is conceivable e.g. to register a license plate number or another identifying feature of the transport device in an original registration step wherein the license plate number or the other identifying features is logically associated with the transport device in the database. When the same identifying feature is captured thereafter, e.g. the license plate number, comparing with the data captured during the registration step enables a determination whether the transport device to be cleaned is the transport device that is associated with the identification feature, e.g., the license plate number.

As soon as the cargo space of the respective transport device is cleaned, a cleaning certificate is automatically generated that documents completion of the cleaning of the cargo space. Thereafter, this cleaning certificate is stored in a database and linked to the transport device. This can be the same database where the information regarding the transport device is stored.

Performing the identification of the respective transport device is essential for the success of the method, however, the sequence of performing the cleaning of the respective cargo space and the identification of the transport device is not essential. Thus, it is conceivable to automatically clean the cargo space using the cleaning robot and the identification of the transport device is performed before the cleaning, during the cleaning, or after the cleaning. It is essential for the success of the invention that the identification of the transport device is performed, so that the cleaning certificate that is automatically generated after completing of the cleaning is associated with the transport device and stored in the database linked to the transport device. It is also conceivable to print out the cleaning certificate.

The method according to the invention has many advantages, It is feasible, in particular, to automate generating and storing the cleaning certificate as a proof of a successful cleaning of the respective cargo space and to store the cleaning certificate so that a subsequent call-up can be performed from the database anytime. Thus, documentation and management of performed and completed cleaning processes of a transport device is simplified over the prior art, in particular when a plurality of transport devices is provided.

Advantageously, the completed cleaning certificate is automatically associated with a user account that is linked to the transport device. Thus, an operator of a fleet of transport devices can have a user account in which all transport devices of the fleet are stored. The identification of at least one identification feature initially determines which transport device of the fleet is to be cleaned, so that the cleaning certificate is stored for the respective transport device in the respective user account. In order to manage the account, it is only necessary to log into the user account and thereafter the cleaning certificates of individual transport devices are reviewable in a simple manner and can be downloaded. It is also conceivable to provide single access or plural accesses to the user account for third parties which may receive limited access to the user account. This way, third parties can review one or plural cleaning certificates independently.

Advantageously, the at least one sensor that captures the at least one identification feature of the transport device is formed by an optical sensor, e.g. a camera. This sensor is able to capture optical information, in particular in a form of individual pictures or in a form of moving images. A sensor of this type is particularly well suited to capture a plurality of different identification features so that processing of the captured information facilitates an identification of the transport device.

As recited supra, it is particularly advantageous when at least one identification feature of the respective transport device is formed by a vehicle license plate number. Vehicle license plate numbers are optically detectable in a particularly simple manner and are typically arranged in the same area of the transport device for a particular type of transport device so that the sensor used for identifying the vehicle license plate number can be targeted to that area. It is also conceivable to capture information regarding transport devices that do not have a vehicle license plate number. This can be the case for an ocean container. The ocean container is identified by another identification feather, e.g. an RFID chip, a QR code and/or a bar code.

According to a particularly advantageous embodiment of the method according to the invention, information regarding the identified transport device stored in the database is retrieved. Thereafter, at least one operating parameter of the cleaning robot can be automatically adjusted for performing at least one cleaning process and/or a type of the cleaning process. In order to perform the method, it is essential that the identification of the transport device is performed at least before a last cleaning process of the respective cleaning run so that the adjustment of at least one operating parameter of the cleaning robot can be performed for this cleaning process automatically and becomes effective automatically. Advantageously the identification of the transport device is performed before beginning to clean the cargo space. The type of the last transported cargo can be stored in the database with respect to the respective transport device and the next cleaning can be predetermined as a function of the cargo transported last. Food products may have been transported in the cargo space which require a different type of cleaning compared to transporting furniture. Based on the information stored in the database regarding the transport device, the cleaning robot can be automatically configured so that operating parameters of the cleaning robots are automatically adjusted so that the cleaning robot can clean the cargo space in a controlled manner. It is also conceivable that cleaning fluid that is to be dispensed by the cleaning robot is mixed with a high concentration of the cleaning agent in order to achieve a comparatively high cleaning effect. Increasing a dispensing amount of the cleaning fluid or adjusting a predetermined temperature of the cleaning fluid and similar is also conceivable. Adjusting the operating parameters can be performed in particular by a control unit of the cleaning robot and/or by a data processing device. This is described based on the subsequent embodiment.

A method of this type can be particularly advantageous where information regarding a contamination condition of the cargo space is captured by the at least one sensor. This can be advantageous in particular before a beginning of a cleaning process. This information is transmitted to the data processing device and managed by the data processing device wherein at least one operating parameter of the cleaning robot for the at least one cleaning process is automatically adjusted as a function of the processed information. The sensor can be formed in particular by an optical sensor, wherein the same sensor is advantageously used for capturing the contamination condition of the cargo space. Wherein the same sensor is used for capturing the information regarding the at least one identification feature of the transport device. Performing the cleaning of the cargo space can be executed as required through the automatic adjustment of at least one operating parameter as a function of a detected contamination condition, wherein in particular a consumption of cleaning agent and cleaning fluid is only performed as actually required for cleaning the cargo space.

It is conceivable in particular to only temporarily adjust an increased dispensing amount of the cleaning fluid when a local contamination, e.g. at a wall of the transport device is detected during a cleaning process whereas the rest of the cleaning process is performed with a reduced dispensing amount that suffices for cleaning the walls. Accordingly it can be particularly advantageous when at least one operating parameter is automatically adjusted during the cleaning process as a function of processed information regarding the contamination condition of the cargo space, at least once, advantageously several times.

It can also be particularly advantageous when a contamination condition of the cargo space is captured after a cleaning process has been performed. This way, it can be checked whether an intended cleaning result has been achieved, this means the cleaning that has been performed satisfies predetermined requirements. If this is not the case, an additional cleaning process can be performed. When the cleaning success has been achieved this can be recorded in the cleaning certificate. Thus, it can be advantageous when the cleaning certificate is generated so that it documents the cleaning success achieved. A camera and/or at least one lidar can be used as a sensor suitable for capturing a contamination condition.

It is furthermore conceivable to store information in the database wherein the information relates to an intended cleaning success of the transport device to be cleaned. It is also conceivable to clean a respective transport device particularly intensively since it has been used for transporting live animals. It can therefore be defined regarding the transport device that a cleaning is only considered successful when certain requirements have been met. When the sensor determines that the cargo space is not contaminated anymore, in a way that the cleaning is to be considered unsuccessful in view of the requirements, the cleaning success is automatically determined. Advantageously, data regarding the requirements or the intended cleaning success can be downloaded from the database due to the identification of the transport device or the cargo space to be cleaned.

It can be particularly advantageous to capture information regarding dimensions of the cargo space using at least one sensor. This information can be processed in order to control the cleaning robot while performing the cleaning. This can relate in particular to controlling a suspension or adjusting operating parameters of the cleaning robot. The at least one sensor is advantageously configured as a lidar. This sensor enables capturing dimensions of the cargo space in a particularly simple manner.

In a particularly advantageous embodiment, at least one operating parameter of the cleaning robot that is automatically adjustable is formed by one of the following:
orientation of at least one cleaning nozzle;
dispensing pressure of a cleaning fluid at the at least one cleaning nozzle;
dispensing volume of the cleaning fluid at the at least one cleaning nozzle;
activation condition of the at least one cleaning nozzle;
distance of the at least one cleaning nozzle from a wall of the cargo space;
temperature of the cleaning fluid;
movement speed of the cleaning robot;
concentration of a cleaning agent in the cleaning fluid;
distance of the cleaning robot from a wall of the cargo space.

These operating parameters are particularly well suited to adjust a cleaning performance of the cleaning robot as required. Additional operating parameters are also conceivable.

In another advantageous embodiment of the method according to the invention, at least one sensor captures information regarding obstacles arranged in the cargo space before a beginning of the cleaning process. The sensor used for this purpose can be advantageously configured as an optical sensor or as a camera or as a lidar. The sensor can be formed e.g. by the same sensor that captures information regarding the at least one identification feature. The information regarding obstacles arranged in the cargo space is then transmitted to the data processing device and processed by the data processing device. This helps to detect an obstacle, wherein detecting the obstacle, e.g. a piece of wood, controls the cleaning robot automatically so that the beginning of the cleaning process is prevented until the obstacle is removed or the cleaning process is interrupted if it has started already. This process substantially improves operation safety of the cleaning robot wherein damaging the cleaning robot due to a collision with an obstacle is prevented. It is also conceivable that a respective cleaning process is influenced negatively beyond a damage risk to the cleaning robot so that the cleaning may not be performed in an optimal manner, possibly without that being detected, though the cleaning appeared to be completed without problem. Identifying obstacles and removing them is particularly advantageous.

In another advantageous embodiment of the method, the cleaning process includes a drying step that dries the cargo space. In order to perform the drying step, air, in particular, heated air, can be applied to surfaces of the walls of the transport device, in particular, to the cargo space floor. This can be performed, in particular, by a fan, wherein the cleaning nozzles are used for dispensing the air, which are also used for dispensing the cleaning fluid. Drying the cargo space in order to clean the cargo space is particularly advantageous in order to directly prepare the cargo space for further use. Removing the moisture also prevents a renewed generation of germs or similar.

According to another advantageous embodiment of the method, the cleaning fluid that is used for at least one cleaning process is at least partially captured after being dispensed into the cargo space and subsequently at least partially processed. The cleaning fluid thus processed can be at least partially used for performing another cleaning process. Depending on the type of cleaning it can also be required to treat the captured cleaning fluid before it is drained into a public sewer. The efficiency of overall operations of a respective cleaning robot or of an associated cleaning station can be improved by performing this method step since a use of new cleaning agent can be significantly reduced. Thus, the method for cleaning the cargo space is performed in an ecologically advantageous manner.

In an advantageous embodiment of the method according the invention, telemetry data, in particular, location data, is captured and processed for a cargo space of a respective transport device when a cleaning is booked. Thereafter, a time window for performing the cleaning is automatically reserved as a function of the processed telemetry data. This has the effect that the respective cleaning station that includes the cleaning robot is made available for the respective transport device in the reserved time window. Thus, a use by third parties is temporarily prevented in the reserved time window. Particularly advantageously, the time window can be adjusted as a function of the detected telemetry data, e.g. when an adjustment of a projected arrival time of the respective transport device at the respective cleaning station is predeterminable. This can be helpful in case of traffic jams. The identification of the respective transport device based on at least one identification feature then enables clearing the cleaning station or the cleaning robot for performing the cleaning of the respective cargo space. This way, reserving and activating the cleaning robot for performing a cleaning can be organized and executed in an automated manner. This is particularly advantageous for the operator of the transport device since manual management and organization can be omitted.

### BRIEF DESCRIPTION OF THE DRAWINGS

The invention is subsequently described based on an advantageous embodiment with reference to drawing figures, wherein:

FIG. 1 illustrates a vertical longitudinal sectional view of a set including a cleaning station and a transport device;

FIG. 2 illustrates a horizontal sectional view of the set according to FIG. 1;

FIG. 3 illustrates a perspective view of a cleaning station;

FIG. 4 illustrates a front view of the cleaning station according to FIG. 3.

FIG. 5 illustrates a vertical longitudinal sectional view of the cleaning station according to FIG. 3;

FIG. 6 illustrates a perspective view of a cleaning robot;

FIG. 7 illustrates a front view of the cleaning robot according to FIG. 6; and

FIG. 8 illustrates a side view of the cleaning robot according to FIG. 6.

### DETAILED DESCRIPTION

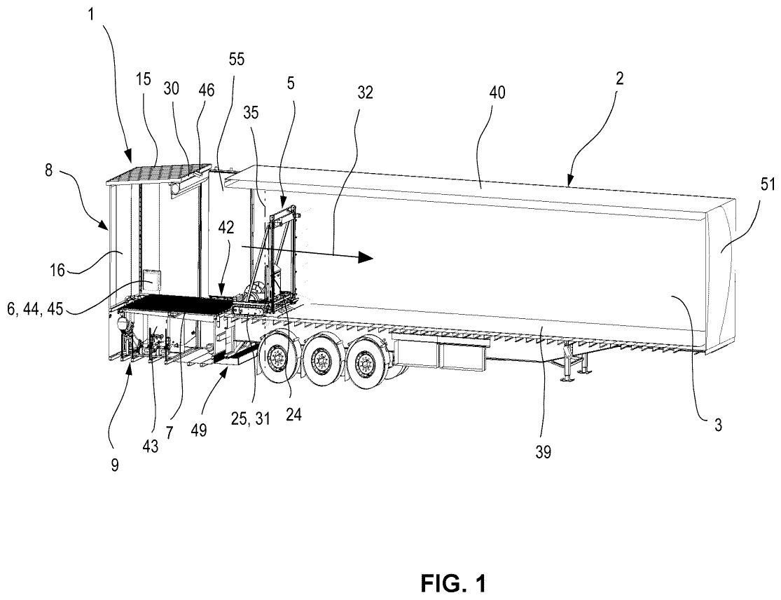

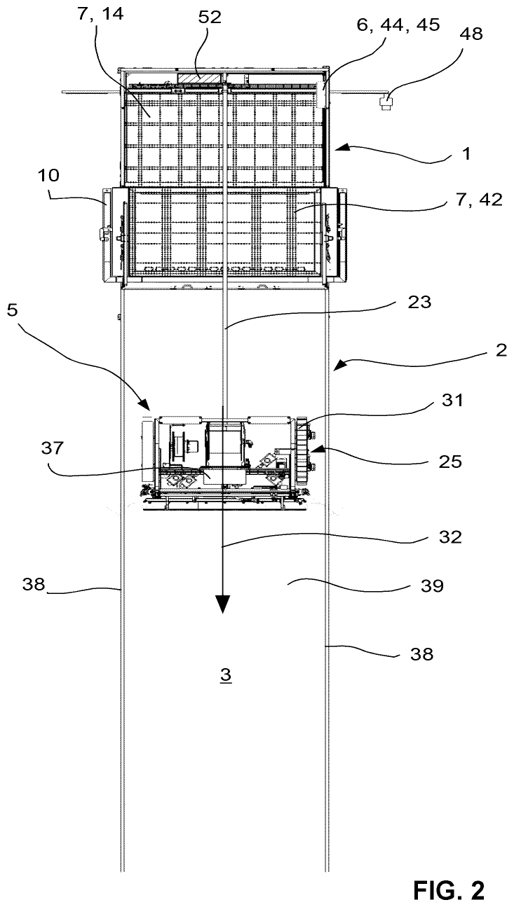

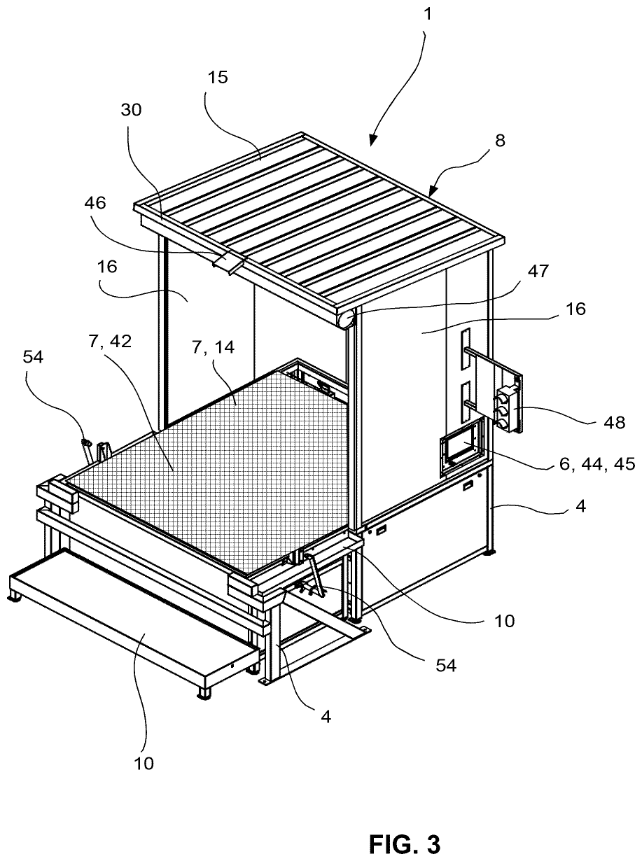

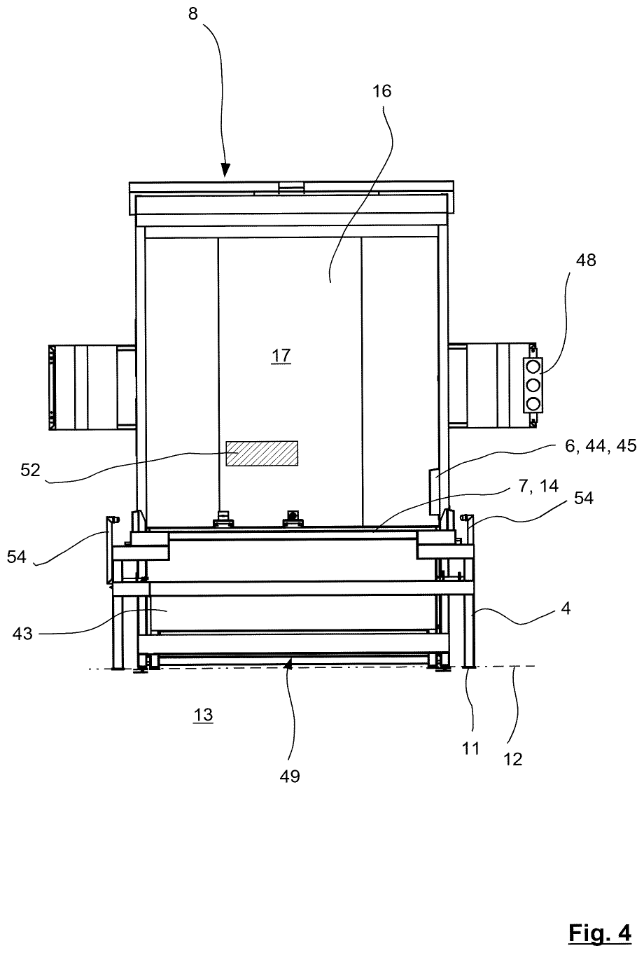

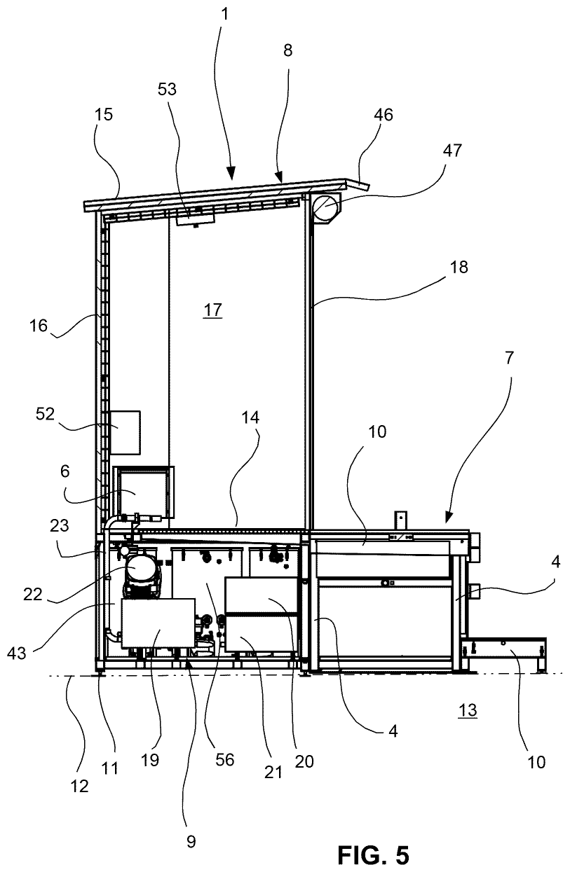

An advantageous embodiment illustrated in FIGS. 1-8 includes a cleaning station 1 including a cleaning robot 5 for cleaning a cargo space 3 of a transport device 2. The transport device 2 is formed in this embodiment by a trailer with a cargo space 3 that is to be cleaned. In order to perform the cleaning, the transport device 2 is positioned relative to the cleaning station 1 so that the cleaning robot 5 can enter the cargo space 3 of the transport device 2. The cleaning robot 5 is provided and configured to perform the cleaning of the cargo space 3 self-acting or automatically, this means, in particular, without interaction from a user of the cleaning station 1.

The cleaning station 1 that is illustrated in FIGS. 1-5 includes a support frame 4 that forms a pedestal 7 at an end oriented away from a ground 13. The pedestal 7 is thus offset from the ground 13, wherein the pedestal 7 forms a flat driving plane that is oriented essentially parallel to a surface of the ground 13. The arrangement of the pedestal 7 as described supra enables the cleaning robot 5 that is supported on the pedestal 7 to enter the cargo space 3 of the transport device 2 from the pedestal 7 without having to cover an elevation difference, wherein the pedestal 7 and a cargo space floor of the transport device 2 are at least on a similar, advantageously on the same elevation level.

The cleaning station 1 furthermore includes a garage 8 in which the cleaning robot 5 is storable in a parking position when not in use. The garage 8 includes a plurality of side walls 16, a floor 14, a ceiling 15, wherein these elements jointly enclose an interior space 17 of the garage 8. The interior space 17 is defined by a side wall 16 towards a front side of the garage 8, wherein the side wall 16 is formed by an openable space divider 18. The space divider 18 is optionally moveable between an open position and a closed position. In the illustrated embodiment, the space divider element 18 is formed by a rolling door which is rolled up and stored in a storage box 47 when the space divider element 18 is provided in its open position. When the space divider 18 is in its closed position, it secures the interior of the garage 8 against unauthorized access. The floor 14 of the garage 8 is formed by the pedestal 7 in the illustrated embodiment so that the floor 14 of the garage 8 extends from an outer area 42 of the pedestal 7 without any elevation difference. Thus, the cleaning robot 5 can move out of the garage 8 without having to drive up or down a step or a ramp or similar.

The support frame 4 of the cleaning station 1 includes a plurality of stand elements 11 which support the cleaning station on the ground 13 in a support plane 12. As stated supra, the pedestal 7 is oriented parallel to the support plane 12. Since there is a distance between the support plane 12 and the pedestal 7, an intermediary space 43 is provided between the pedestal 7 and the support plane 12 wherein a fluid supply 9 is arranged in the intermediary space 43. The fluid supply includes a plurality of fluid tanks 19, 20, 21, and a pump 22. A first fluid tank 19 is formed by a water tank and is configured to store fresh water in the illustrated embodiment. The first fluid tank 19 can be configured with a supply connection in the illustrated embodiment, wherein the fluid tank 19 is connectible to an external supply conduit so that it is fillable with fresh water, e.g. from a municipal water supply. The fluid supply 19 also includes a second fluid tank 20 which is formed by a cleaning fluid tank. Thus, the second fluid tank 20 is configured to store a cleaning fluid that is provided for dispensing into the cargo space 3 by the cleaning robot 5. The third fluid tank 21 is configured as a cleaning fluid tank to store the cleaning fluid which is typically formed by a particular chemical mixture. The cleaning fluid that is stored in the second fluid tank 20 is typically formed by a mixture which includes captured cleaning fluid which was previously applied by the cleaning robot 5 and then captured again by the capture device 49 and fresh cleaning fluid. The cleaning robot 5 is supplied with the cleaning fluid from the second fluid tank 20 which is flow-connected with the cleaning robot 5 by a fluid conduit 23. The pump 22 cooperates with the fluid conduit 23 so that it is configured to pump the cleaning fluid stored in the fluid tank 20 through the fluid conduit 23 into the cleaning robot 5 that eventually sprays the cleaning fluid.

The cleaning station 1 further includes a capture device 9 which includes plural capture containers 10 in the illustrated embodiment wherein the capture containers are configured to capture and re-circulate cleaning fluid dispensed during the cleaning of the transport device 2. Individual capture containers 10 are respectively arranged at a level below an upper driving plane of the pedestal 7 for this purpose. Additionally, the driving plane of the pedestal 7 where the cleaning robot 5 can drive is formed by a grate so that dispensed cleaning fluid 10 can drain downward through the grate and can be supplied to the capture device 49 in this way.

The cleaning station 1 can additionally include a processing device 56 wherein captured cleaning fluid is feedable to the capture device, in particular, by a pump. The processing device 56 facilitates processing the cleaning fluid so that the cleaning fluid is at least partially suitable for performing another cleaning process. Processing the cleaning fluid can be performed, in particular, by filtering solids out of the cleaning fluid using one or plural filters. The portion of the processed cleaning fluid that is suitable for further use is then fed into the second fluid tank 20. As stated supra, additional cleaning fluids can be fed into the fluid tank 20.

The cleaning station 1 additionally includes an energy supply configured to supply the cleaning station 1 and, in particular, the cleaning robot 5 with electrical energy. This supply can be performed indirectly or directly wherein in particular a certain amount of electrical energy can be stored in an intermediary battery. The energy supply includes a supply connection that is connectible with an external supply conduit.

Additionally, the cleaning station 1 includes a control unit 6 that is fixed at a sidewall of the garage 8. The control unit 6 is configured and provided to control the cleaning station 1 and, in particular, the cleaning robot 5. For this purpose, the control unit 6 is connected in a data transferring manner with the cleaning robot 5 by at least one data connection. This data connection can be hardwired or provided wirelessly. In the illustrated embodiment, the cleaning robot 5 is connected to the cleaning station 1 with an additional supply conduit in addition to the fluid conduit 23, wherein the cleaning robot 5 is suppliable with electric energy from the energy supply and also with data from the control unit 6.

In the illustrated embodiment, the control unit 6 includes a data processing device which is configured to electronically process supplied information. This can be in particular information that is captured by various sensors which will be described infra. Processing this information is used in the illustrated embodiment to control the cleaning robot 5 by the control unit 6 as required and to influence a cleaning process of the storage space 3 of the transport device 2 in this manner.

The control unit 6 includes an input device 44 and a display device 45 in the illustrated embodiment which are combined in a touch screen display. This way, the operator of the cleaning station 1 is enabled to perform inputs relating to at least one cleaning process or the entire cleaning job. It is conceivable, for example, to display options for various cleaning programs to the user through the display 35 wherein the user can select between the cleaning programs. Depending on which of the cleaning programs is selected, at least one cleaning process of the storage space 3 is controlled for the cleaning robot 5 by the control unit 6. Different cleaning programs can cause different operating parameters of the cleaning robot 5 so that the cleaning can be performed in different ways automatically as a function of the selected cleaning program.

The cleaning station 1 additionally includes a signalling device 48 which can be laterally connected to a side wall 16 of the garage 8 like a traffic light. The signalling device 48 can be used for different purposes. In particular, the signalling device 48 can optically indicate to the driver of a respective transport device 2 that a parking position relative to the cleaning station 1 has been reached. It is understood that the transport device 2 has to be positioned relative to the cleaning station 1 so that the cleaning robot 5 can drive from the pedestal 7 into the cargo space 3 of the transport device 2. It is particularly advantageous when only a small or no elevation difference is provided between an elevation level of a cargo space floor 39 of the cargo space 3 to be cleaned and an elevation level of the driving plane of the pedestal 7.

In order to secure the support frame 4 against unintentional impact of a transport device 2 driving into its parking position, it can furthermore be advantageous when the cleaning station 1 includes a crash bumper. The crash bumper is arranged relative to the transport frame 4 so that the transport device 4 initially contacts the crash bumper when driving towards the cleaning station 1 before impacting the support frame 4. The crash bumper can be anchored in the ground e.g. by a foundation. In order to be able to flexibly deploy the cleaning station without ground construction, it is particularly advantageous when the crash bumper is stabilized by the weight of the transport device 2. For this purpose, the crash bumper can include a ram, which is connected at one end at an elongated base plate. The elongated base plate can be oriented relative to the transport frame 4 so that the transport device 2 drives onto the base plate when moving into a parking position at the cleaning station 1 and thus fixes the crash bumper relative to the ground 13 by friction locking.

Furthermore, the signalling device in the illustrated embodiment is configured to optically display an elevation difference between the elevation level of the cargo space floor of the transport device 2 and the elevation level of the driving plane of the pedestal 7 to the driver of the transport device 2. For the reasons recited supra, this elevation difference shall be minimal, advantageously zero so that the cleaning robot does not have to cover any elevation difference when moving from the pedestal 7 into the cargo space 3. An adaptation of the elevation level of the cargo space floor 39 to the elevation level of the pedestal 7 can be performed in particular by the transport device 7, so that the driver can perform the adaptation in view of the signal displayed by the signalling device.

Additionally, the cleaning station 1 includes two door supports 54, wherein one respective door support is arranged at one respective side of the pedestal 7. The door supports 54 are used to stop the doors 55 of the transport device 2 in their open position. This is evident, in particular, from FIG. 1. Due to the extension of the pedestal 7 in its outer area 42, it is possible to position doors 55 of the transport device 2 in their open position respectively, lateral from the pedestal 7 and to make the cargo space accessible for cleaning by the cleaning robot 5 in this way. Thus, the cleaning robot 5 is positioned outside the garage 8 in the outer portion 42 of the pedestal 7 and activated so that the doors 55 arranged laterally from the pedestal 7 are loaded with the cleaning fluid and thus cleaned. The door supports 54 are used to stop the doors 55 during the cleaning so that the cleaning can be performed reliably. In particular, the door supports 54 can respectively include a suction cup that is configured to grip a respective door 55 at an outside through vacuum. The door supports 54 can be arranged at the support frame 4 in a force transferring manner and can react forces into the door frame 4, wherein the forces are generated by stopping the doors 55. Advantageously, the door supports 54 are arranged so that they are suitable for stopping the doors 55 at an opening angle of approximately 90 degrees.

The cleaning station 1 additionally includes a sensor 46 that is formed by a camera in the illustrated embodiment. The sensor 46 is arranged at a front edge 30 of the roof 15 of the garage 8. The sensor 46 is oriented forward in a direction towards a front end of the cleaning station 1 or towards the transport device 2 so that the sensor is configured to capture optical information relating to the transport device 2 and the cargo space 3. The sensor 46 is connected with the data processing device so that data is transferable wherein the data processing device is configured as part of the control device 6 according to the embodiment described supra. This way, it is possible to transfer information captured by the sensor 46 to the data processing device and process the data in the data processing device.

The sensor 46 is configured in particular to capture at least one identifying feature of the transport device 2. In the illustrated embodiment the sensor 46 is configured to optically capture a license plate of the transport device 2, wherein the license plate functions as an identifying feature of the transport device 2. Information captured this way is compared to data already provided in the data processing device relating to the transport device 2 and stored in a database. This database is not configured in the illustrated embodiment locally as part of the data processing device, but is arranged in a cloud, wherein an exchange of data between the database and the data processing device is performed through the internet. Data is stored in the database facilitating an association of the optically captured license plate through the sensor 46 with the transport device 2 so that the transport device 2 is clearly identified whose cargo space 3 is to be cleaned.

The identification of the transport device 2 thus performed is furthermore used to generate a cleaning certificate after the cleaning of the cargo space 3 is completed, wherein the cleaning certificate documents the completed cleaning. This cleaning certificate is then associated with the identified transport device 2 and documented in a database. This can be e.g. the same database that includes the association of the license plate with the transport device 2. This type of data processing provides in particular the option to access the cleaning certificate any time by accessing a user account of a respective customer regarding the transport device 2 that is part of a fleet of that customer and to report the successful performance of the cleaning of the cargo space 2 as may be required by a controlling authority.

Additionally, the identification of the respective transport device 2 can be useful in order to control the cleaning robot 5 for at least one cleaning process that is to be performed. It is conceivable that the type of the transport device 2 is stored in the database with respect to the transport device 2 and which type of contamination of the cargo space 3 is to be expected. The transport device 2 may have been used to transport food products which constitutes certain requirements for cleaning the cargo space 3. Thus, the identification of the transport device 2 facilitates automatically setting at least one operating parameter of the cleaning robot 5 for at least one cleaning process so that the cleaning process can be adapted to the expected contamination and a pre-determined cleaning goal. It is conceivable that the cleaning fluid dispensed by the cleaning robot 5 is heated to a pre-determined temperature for cleaning the cargo space 3 where food products were transported previously in order to efficiently remove the contamination of the cargo space 3. It is also conceivable that the cleaning is performed in view of the next cargo that is to be transported.

Furthermore, the sensor 46 is provided and configured in the illustrated embodiment to optically capture an elevation difference between the elevation of the cargo space floor and the elevation of the driving plane of the pedestal 7 and to conduct the corresponding information to the data processing device. The data processing device is configured to process the information and to provide information to the driver of the transport device 2, e.g. by the signalling device 48 in order to give feedback to the driver regarding the anticipated elevation difference. The driver is subsequently enabled to perform an elevation adjustment of the transport device 2, e.g. by a pneumatic system of the transport device 2. The adaptation is advantageously performed so that no elevation difference exists anymore between the cargo space floor 39 and the pedestal 7.

Last not least the sensor 46 is provided and configured in the illustrated embodiment to optically detect the cargo space 3 or the walls 38, the cargo space floor 39 and/or a cargo space ceiling 40 of the transport device 2. Information captured in this manner is transmitted to the data processing device and processed therewith which enables detecting objects in general and in particular obstacles and/or contamination. The contamination can be provided in particular as contamination at the surfaces of the walls 38, the cargo space floor 39 and/or the cargo space ceiling 40. The data processing device is provided and configured to process the captured information and to control the cleaning robot 5 as a function of the information or as a function of the processing of the information.

The control includes in particular that at least one operating parameter of the cleaning robot 5 is set for at least one cleaning process of the respective cargo space 3. It is also conceivable to locally capture a contamination at a wall 38 of the transport device 2 by the sensor 46 and to control the cleaning robot 5 as a consequence of the processing of the information captured in this manner so that the cleaning robot temporarily reduces its driving speed in the longitudinal direction of the cargo space in an area of the detected contamination. This increases an application of the cleaning fluid to the location of the local contamination so that the contamination is removed in a controlled manner. It is also conceivable that a dispensing amount of the cleaning fluid that is dispensed locally in the area of the contamination by the cleaning robot 5 or a cleaning nozzle 33 is increased temporarily in order to load the contamination with an increased amount of cleaning fluid. This way, the cleaning robot 5 can be controlled as required for a respective cleaning process through the cooperation of the sensor 46 with the data processing unit of the control unit 6. An adjustment of at least one operating parameter of the cleaning robot 5 while performing the cleaning process and/or between different cleaning processes is also possible.

In the illustrated embodiment, as sensor may be formed by a Lidar. This sensor is used to capture dimensions of the cargo space 3. The information thus captured can be used to control the cleaning robot 5 to perform the cleaning automatically and/or to adjust at least one operating parameter for at least one cleaning process.

It is also possible to capture a contaminations condition of the cargo space 3 by a sensor that is formed by a camera or a lidar after completing the respective cleaning process. It is conceivable for example, that remaining solid objects or fluid puddles are detected in the cargo space 3 by the lidar sensor. In case no contamination is detected, the cleaning is deemed sufficient and terminated. An automatically generated cleaning certificate can be the result of the post-inspection of the cargo space 3 wherein the cleaning certificate not only documents that a prescribed cleaning was performed but also documents that an intended cleaning result has been achieved. Thus, it is conceivable that requirements for a cleaning success relating to an identified transport device are stored. Checking these requirements can be performed by sensor detection through at least one sensor, wherein the generated cleaning certificate documents the cleaning success when these requirements are met.

In case a propulsion of the cleaning robot 5 is impaired so that the cleaning robot 5 cannot exit the cargo space of the respective transporter under its own power, it is required to still remove the cleaning robot 5 from the cargo space 3 so that the transport device 2 is clean and can leave the cleaning station 1. This failure can be caused by a chassis 25 of the cleaning robot 5 being damaged or the power supply having failed or similar. In order to reliably remove the cleaning robot 5 from the cargo space 13, the cleaning station 1 includes a winch 52 in the illustrated embodiment wherein the winch 52 is arranged at a rear side wall 16 of the garage 8. The winch 52 includes a storage roller where a pull cable is would up. This pull cable can be connected with the cleaning robot 5 in a force transferring manner so that the pull cable is wound onto the storage roller by a rotation drive of the storage roller so that the cleaning robot 5 is extracted backward from the cargo space 3 against the main direction 32 of the cleaning robot 5. The cable winch 52 can be operated manually by a crank or by an electric drive. The cable winch 52 can be supplied with electrical energy from a battery in order to remain functional when an external power supply fails.

Additionally, the cleaning station 1 includes a cleaning device 53 in the illustrated embodiment, wherein the cleaning device is arranged at a bottom side of the roof 15 of the garage 8. The cleaning device 53 is configured to load the cleaning robot 5 with the cleaning fluid and thus clean the cleaning robot 5 when it is in its parking position in which the cleaning robot 5 is parked in the interior 17 of the garage 8. Thus, the cleaning device 53 can include in particular at least one cleaning nozzle that is configured to spray the cleaning fluid from above onto the cleaning robot 5. After the application of the cleaning fluid has been completed, a flushing with fresh water can be performed by the cleaning device 53. Advantageously, the space divider element 18 is closed when the cleaning of the cleaning robot 5 is performed within the garage 8.

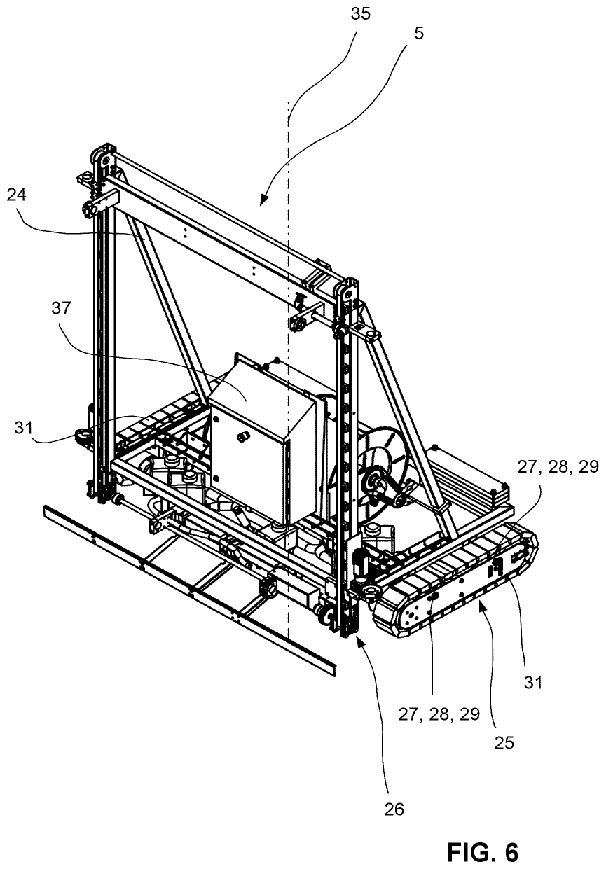

As recited supra, the cleaning of the respective cargo space 3 is performed by the cleaning robot 5 automatically or self-acting. This is evident in particular from FIGS. 6-8. The cleaning robot 5 includes a frame 24 which forms a support frame of the cleaning robot 5. Additionally, the cleaning robot 5 includes a chassis 25 which includes two drive tracks 31 in the illustrated embodiment, wherein the two drive tracks are arranged adjacent and parallel to one another. The drive tracks 31 in turn respectively include a running band or a running chain that is internally closed and drivable to revolve so that the cleaning robot 5 is movable relative to a ground using the drive tracks 31. Thus, the drive tracks 31 are arranged at a bottom side of the frame 24 that is oriented towards the cargo space floor 38 and drivable independently so that the cleaning robot 5 can be moved and controlled like a tank. In particular, a main direction 32 in which the cleaning robot 5 moves forward when synchronously driving the drive tracks 31 can be adjusted by asynchronously driving the drive tracks 31 so that the cleaning robot 5 rotates about its vertical axis 35.

The cleaning robot 5 additionally includes a cleaning unit 26 that is configured to dispense the cleaning fluid onto the walls 38, the cargo space floor 39, the cargo space ceiling 40, and the doors 55 of the transport device 2. Thus, the cleaning unit 26 includes a plurality of cleaning nozzles 33 that are arranged and distributed at the frame 24. The cleaning nozzles 33 are arranged at a front end of the cleaning robot 5 and respectively oriented to the sides or upward and downward in order to apply the cleaning fluid to the associated surfaces of the cargo space 3. In order to adjust the orientation of the cleaning nozzles 33 during a cleaning process, a plurality of the cleaning nozzles 33 is arranged at elongated nozzle rails 36 in the illustrated embodiment wherein the nozzle rails 36 are respectively pivotably supported about a longitudinal axis 34. In the illustrated embodiment, each direction is associated with a nozzle rail 36. This way, it is possible to operate the cleaning nozzles 33 in a first orientation relative to the walls 38, the cargo space floor 39, and the cargo space ceiling 40 when the cleaning robot 5 moves forward in the main direction 32. After reaching a face wall 51 of the transport device 2, the drive direction of the drive tracks 31 is reversed so that the cleaning robot 5 moves backward opposite to the main direction 32 back towards the pedestal 7. Before the reverse movement starts, the nozzle rails 36 are pivoted about their respective longitudinal axis 34 in order to remove dislodged contaminations from the cargo space 3 so that the cleaning nozzles 33 are oriented backward. This way, continued operation of the cleaning nozzles 33, this means spraying the cleaning fluid, flushes the contaminations in the direction of the pedestal 7 and out of the cargo space 3.

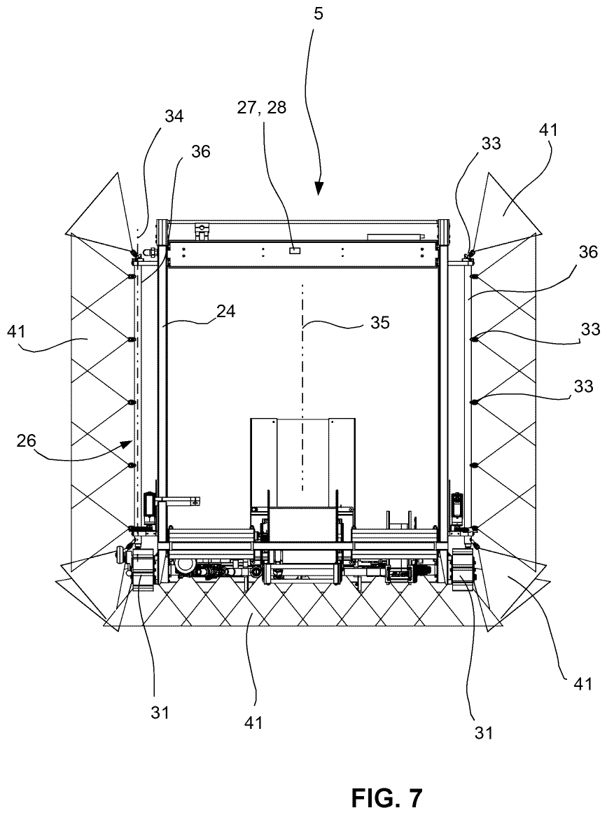

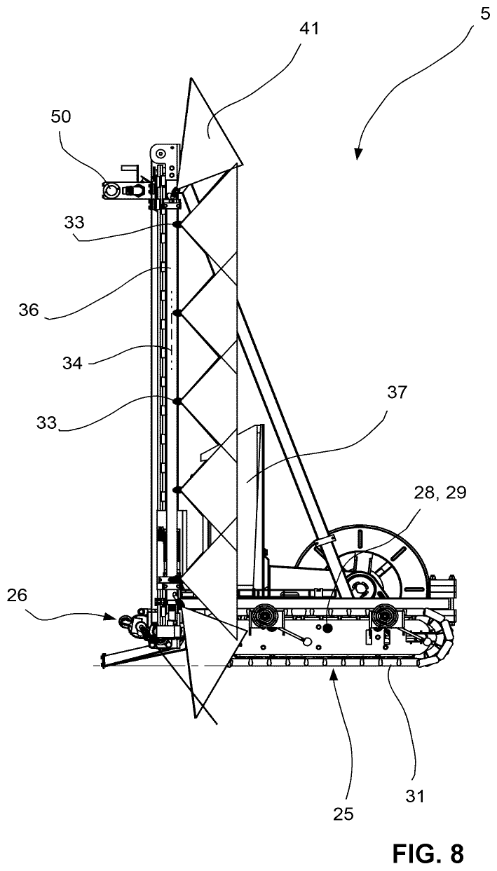

Dispensing the cleaning fluid through the cleaning nozzles 33 in spray cones 41 is shown in FIGS. 7 and 8. Adjusting the cleaning nozzles 36 is shown in the illustrated embodiment motor driven, wherein an electric drive is associated with each nozzle rail 36. The adjustability of the nozzle rails 36 and thus of the dispensing direction of the cleaning nozzles 33 is advantageous for targeted removal of local contaminations or dirt spots. Advantageously, these dirt spots can be sprayed with the cleaning fluid from different directions so that the dirt spots are scraped from the respective surface like using a high-pressure cleaner. Adjusting the dispensing direction of the cleaning fluid helps to achieve a particularly high cleaning performance.

Additionally, the cleaning unit 26 includes a plurality of valves configured to adjust the supply of the cleaning fluid to the individual nozzle rails. The valves can be used for throttling a flow-through amount of the cleaning fluid and also for cutting off plural nozzle rails completely. This way, it is possible to apply the cleaning fluid in a controlled manner to particular locations of the cargo space 3, e.g. to a strong contamination on a surface of a wall 38 of the transport device 2 which is not present in the same severity at the other walls 38.

Furthermore, it is particularly advantageous when the upper, transversally-extending nozzle rail 50 that is shown in FIG. 8 is moved downward along the frame 24 after reaching the face wall 51 of the transport device 2 and reversing the driving direction of the cleaning robot 5. This way, it is possible to apply the cleaning fluid to the face wall 51 through the cleaning nozzles 33 that are arranged at the nozzle rail 50 so that the face wall 51 is cleaned, as well. Accordingly, the cleaning robot 5 is configured so that the nozzle rail 50 is vertically moveable along the frame 24, e.g., by a threaded rod that is drivable to rotate. Before the cleaning robot 5 starts driving backwards, the nozzle rail 36 is moved up again so that it can clean the cargo space ceiling 40 during the backward movement. In order to change the orientation of the cleaning nozzles 33 that are arranged at the transversally-extending nozzle rail 50, the nozzle rail 50 cooperates with the electrical drive as described supra that pivots the nozzle rail 50 about its longitudinal axis 34. Thus, the cleaning nozzles 33 can be oriented towards the face wall 51 at least during the downward movement of the nozzle rail 50.

The cleaning robot 5 in the illustrated embodiment furthermore includes an electrical cabinet 37 which may include, in particular, a control unit 6. This is particularly advantageous in an embodiment where the control unit 6 that is arranged in the illustrated embodiment at the support frame 4 or at the garage 8 is locally arranged at the cleaning robot 5. Additionally, the electrical cabinet 37 can include additional switching devices for locally controlling the cleaning robot 5.

The cleaning robot 5 additionally includes a sensor device 27 including a plurality of sensors 28. The plurality of the sensors 28 is formed, in particular, by distance sensors 29, wherein two respective distance sensors 29 are arranged at the drive tracks 31 in the illustrated embodiment. This is evident, in particular, from FIG. 6. The distance sensors 29 can also be arranged laterally at the frame 24. The distance sensors 29 are used to detect a lateral distance of the cleaning robot 5 from the lateral walls 38 of the transport device 2, this means from the left side and also from the right side of the cleaning robot 5. The distance sensors 29 are thus formed by ultrasound sensors. Determining the distances of the cleaning robot 5 from both sides with reference to the side walls 38 of the transport device 2 facilitates determining the orientation of the cleaning robot 5 or the main direction 32 of the cleaning robot 5 with reference to a longitudinal axis of the cargo space 3. Thus, information captured by the distance sensors 29 is conducted to the data processing device and processed by the data processing device. It has to be prevented during a cleaning process of the cargo space 3 that the cleaning robot 5 contacts the walls 38 of the transport device 2 while driving, in particular a collision has to be prevented. Therefore, the orientation of the main direction 32 relative to the longitudinal axis of the cargo space 3 is very important.

The information captured by the distance sensors 29 is used to determine the orientation of the cleaning robot 5 within the cargo space 3 and correct the orientation as needed. In order to perform this correction, a rotation of the cleaning robot 5 about its vertical axis is required. Also in order to perform this rotation, information captured by the distance sensors 29 as recited supra is processed by the data processing device and the chassis 25 is controlled by the data processing device, in this case directly by the control unit 6, so that the drive tracks 31 of the chassis 25 of the cleaning robot 5 are operated asynchronously. It is also conceivable that only one of the drive tracks 31 is driven while the other drive track 31 is at a standstill. It is also possible that the drive tracks 31 are temporarily driven in opposite directions or with different speeds in the same direction. This concept and other concepts cause the intended rotation of the cleaning robot 5 about the vertical axis 35 and thus an adjustment of the main direction 32 in which the cleaning robot 5 travels when the drive tracks 31 are driven synchronously. This way, the cleaning robot 5 can be oriented in a particularly simple manner within the cargo space 3 so that the cleaning robot travels parallel to the longitudinal axis of the cargo space 3 during the cleaning process. Distances of the cleaning robot 5 from the lateral walls 38 can be checked continuously wherein a correction of the main direction 32 can be performed repeatedly as described supra. Thus, the orientation of the cleaning robot 5 can be performed within the cargo space 3 without having to establish physical contact to the lateral walls 38. Additionally, it is possible in a particularly simple manner to position the cleaning robot 5 at least essentially centrally between the lateral walls 38 of the transport device 2, so that the lateral distances of the cleaning robot 5 from the walls 38 are kept at least essentially equal.

Furthermore, the sensor device 27 includes additional sensors 28 that are formed by distance sensors 29. In particular, a distance sensor 29 is arranged at a front side of the cleaning robot 5 and oriented in the main direction 32 so that a distance of the cleaning robot 5 from an obstacle arranged in the main direction of the cleaning robot 5 is detectable. This way, the cleaning robot 5 can be positioned in a particularly simple manner relative to the front face wall 51 of the transport device 2, so that the cleaning robot 5 can be stopped in a timely manner before colliding with the front face wall 51. Additionally, the sensor device 27 includes a distance sensor 29 oriented in a rear direction of the cleaning robot 5. This sensor can be particularly advantageous for moving into the parking position within the garage 8, wherein a distance of the cleaning robot 5 from the rear wall 16 of the garage 8 can be detected.

The sensor device 27 includes an additional sensor 28 in this embodiment that is formed by a combined temperature and humidity sensor. This sensor 28 facilitates capturing information regarding temperature and humidity in the cargo space 3 during a cleaning process. This information is processed, in particular, by the data processing device of the control unit 6, so that an operating parameter of the cleaning robot 5 can be adjusted as a function of the detected information. The captured information can also be used to monitor the cleaning and to assure and document the quality of the cleaning. Respective data can be documented as part of the cleaning certificate recited supra.

Additional sensors 28 can be formed, e.g. by a pressure sensor or a flow-through sensor that are configured to capture information relating to the cleaning fluid. Thus, it can be determined which flow-through amount of cleaning fluid is dispensed at a nozzle rail 36 or what pressure is applied to dispense the cleaning fluid through the cleaning nozzles 33. This information can be used to adjust the control of the cleaning robot 5 and to influence the operating parameters accordingly. Disturbances in the fluid supply 9 are also detectable wherein a sudden drop of the pressure of the flow-through amount of the cleaning fluid indicates a disturbance.

After dispensing the cleaning fluid successfully through the cleaning unit 26, it is conceivable that the cargo space 3 is dried in order to complete the cleaning. Thus, it is conceivable to apply an air flow in particular to the cargo space floor 39 or to the walls 38 and the cargo space ceiling 40 using the cleaning nozzles 33 or separate air outlets, which dries out humidity caused by the dispensing of the cleaning fluid.

### REFERENCE NUMERALS AND DESIGNATIONS

1 Cleaning station
2 Transport device
3 Cargo space
4 Support frame
5 Cleaning robot
6 Control unit
7 Pedestal
8 Garage
9 Fluid supply
10 Capture container
11 Stand element
12 Contact plane
13 Ground
14 Floor
15 Ceiling
16 Side wall
17 Interior space
18 Space divider element
19 Fluid tank
20 Fluid tank
21 Fluid tank
22 Pump
23 fluid conduit
24 Frame
25 Chassis
26 Cleaning unit
27 Sensor device
28 Sensor
29 Distance sensor
30 Edge
31 Drive track
32 Main direction
33 Cleaning nozzle
34 Longitudinal axis of nozzle rail
35 Vertical axis
36 Nozzle rail
37 Electrical cabinet
36 Wall
39 Cargo space floor
40 Cargo space ceiling
41 Spray cone
42 Outer portion of pedestal
43 Intermediary space
44 Input device
45 Display device
46 Sensor
47 Storage box
48 Signaling device
49 Capture device
50 Nozzle rail
51 Face wall
52 Cable winch
53 Cleaning device
54 Door support
55 Door
56 Processing device

What is claimed is:

1. A method for cleaning a cargo space of a transport device, the method comprising:
automatically cleaning the cargo space through a cleaning robot;
capturing information including an identification feature of the transport device through a sensor and transmitting the information to a data processing device;
comparing the captured information through the data processing device with information stored in a database relating to the transport device so that the transport device is identified;
automatically generating a cleaning certificate after cleaning the cargo space of the transport device, wherein the cleaning certificate documents completing cleaning the cargo space; and
storing the cleaning certificate in a database so that the cleaning certificate is linked to the transport device.

2. The method according to claim 1, wherein the cleaning certificate is associated with a user account wherein the transport device is associated with the user account.

3. The method according to claim 1, wherein the sensor is formed by an optical sensor or by a camera, wherein the optical sensor captures optical information in a form of individual still images or moving images.

4. The method according to claim 3, wherein a vehicle license plate of the transport device and/or a RFID chip and/or a QR code and/or a bar code is captured as the identification feature.

5. The method according to claim 1,
wherein information regarding the identified transport device and stored in the database is retrieved,
wherein an operating parameter of the cleaning robot is automatically adjusted as a function of the retrieved information for performing the cleaning or for determining a type of the cleaning.

6. The method according to claim 1,
wherein the sensor captures information regarding a contamination condition of the cargo space,
wherein the information is transmitted to the data processing device and processed by the data processing device.

7. The method according to claim 6, wherein an operating parameter of the cleaning robot is automatically adjusted as a function of the processed information.

8. The method according to claim 6, wherein the operating parameter of the cleaning robot is adjusted as a function of the processed information or adjusted automatically several times during the cleaning process.

9. The method according to claim 6,
wherein the information regarding a contamination condition of the cargo space is captured after completion of the cleaning process,
wherein a cleaning success is documented when generating the cleaning certificate if a contamination condition of the cargo space complies with predetermined requirements after completion of the cleaning process.

10. The method according to claim 5, wherein the operating parameter of the cleaning robot is formed by:
an orientation of a cleaning nozzle;
a dispensing pressure of a cleaning fluid at the cleaning nozzle;
a dispensing volume of the cleaning fluid at the cleaning nozzle;
an activation condition of the cleaning nozzle;
a distance of the cleaning nozzle from a wall of the cargo space;
a temperature of the cleaning fluid;
a movement speed of the cleaning robot;
a concentration of a cleaning agent in the cleaning fluid; and
a distance of the cleaning robot from a wall of the cargo space.

11. The method according to claim 1,
wherein information regarding an obstacle arranged in the cargo space is captured by the sensor before the cleaning process begins,
wherein the information regarding the obstacle is transmitted to the data processing device and processed by the data processing device so that the obstacle is detected and the cleaning robot is controlled as a function of the information regarding the obstacle so that a beginning of the cleaning process is prevented until the obstacle is removed.

12. The method according to claim 1,
wherein information regarding dimensions of the cargo space is captured by the sensor before a beginning of the cleaning process,
wherein the information regarding the dimensions of the cargo space is transmitted to the data processing device and processed by the data processing device, and
wherein the cleaning robot is controlled as a function of the captured information regarding the dimensions of the cargo space.

13. The method according to claim 1, wherein the cleaning includes a drying step wherein heated air is conducted onto surfaces to be dried by a fan.

14. The method according to claim 1,
wherein a cleaning fluid that is used for performing the cleaning is at least partially captured after being dispensed into the cargo space and at least partially processed,
wherein at least a portion of the processed cleaning fluid is at least partially used for performing another cleaning.

15. The method according to claim 1,
wherein telemetry data of the transport device or location data, is captured and processed when the cleaning of the cargo space of the transport device is booked,
wherein a time window for performing the cleaning is automatically reserved as a function of the processed telemetry data or location data.
